(19) United States
(12) Patent Application Publication
(10) Pub. No.: US 2022/0033068 A1
(43) Pub. Date: Feb. 3, 2022

(54) SELF-ADHERING FILM WITH AERODYNAMIC PERFORMANCE

(71) Applicant: 3M INNOVATIVE PROPERTIES COMPANY, St. Paul, MN (US)

(72) Inventors: Haruyuki MIKAMI, Gotemba-shi (JP); Ken OKURA, Higashine (JP); Takayuki Tachihara, Sagamihara-shi (JP)

(21) Appl. No.: 17/290,459

(22) PCT Filed: Nov. 14, 2019
(86) PCT No.: PCT/IB2019/059800

§ 371 Date: Apr. 30, 2021

(30) Foreign Application Priority Data
Nov. 14, 2018 (JP) 2018-213967

(51) Int. Cl. B64C 21/10; B29D 7/01; F15D 1/12; F15D 1/00

(52) U.S. Cl. CPC B64C 21/10; B29D 7/01; B64C 2230/26; F15D 1/0035; F15D 1/12

(57) ABSTRACT

Provided is the film that can reduce aerodynamic drag and enhance aerodynamic performance. The film according to an embodiment is a film (1) to be attached to a moving body that moves in a predetermined moving direction, extends along a second direction (D2) being the moving direction, and includes recesses and protrusions (2A) configured to enhance aerodynamic performance of the moving body on a surface of the film.

### TECHNICAL FIELD

One aspect of the present disclosure relates to a film.

### BACKGROUND ART

Patent Document 1 describes a method of reducing a resistance force and a resistance-force reduction item. As the resistance-force reduction item, a sheet material is described. The sheet material includes a pattern surface on a front surface, and a cross section of a pattern layer is a serrated cross section having a plurality of mountains and a plurality of valleys. Further, the sheet material including an adhesive layer on a surface opposite to the pattern surface is described. The sheet material reduces a resistance force of an item when the adhesive layer is attached to the surface of the item.

### SUMMARY OF INVENTION

Incidentally, a moving body, for example, a vehicle, an airplane, a blade of a wind power plant, or the like exerts a function of transporting passengers or items, generating power, or the like by moving in a predetermined direction. The moving body as described above exerts the above-mentioned functions by fuel such as gasoline and oil. Further, aerodynamic drag is caused to the moving body when the moving body movies in the moving direction. Along with increase in aerodynamic drag, there arises concern over increase in cost such as fuel consumption. Therefore, enhancement of aerodynamic performance is an important key in some cases.

The film according to one aspect of the present disclosure is a film to be attached to a moving body that moves in a predetermined moving direction, extends along the moving direction, and includes recesses and protrusions configured to enhance aerodynamic performance of the moving body on a surface of the film.

The film according to one aspect is a film that enhances aerodynamic performance of the moving body, and the recesses and protrusions extending in a moving direction of the moving body are formed on the surface of the film. Thus, on the moving body to which the film is attached, air being resistance against moving flows smoothly along the recesses and protrusions when the moving body moves in the moving direction. With this, air resistance caused on the surface of the moving body can be reduced. The film including the recesses and protrusions extending in the moving direction of the moving body is attached to the moving body. With this, air resistance during moving of the moving body can be reduced, and aerodynamic performance can be enhanced. As a result, fuel consumption of the moving body can be reduced, and hence cost such as fuel consumption can be reduced.

The film may include a hydrophilic coating layer configured to coat the recesses and protrusions.

The film may include a hydrophobic coating layer configured to coat the recesses and protrusions.

The film may include an adhesive agent layer configured to cause the film to adhere to the moving body.

The film may include an intermediate layer that is positioned between the recesses and protrusions and the adhesive agent layer.

### Advantageous Effects of Invention

According to the present disclosure, aerodynamic drag can be reduced, and aerodynamic performance can be enhanced.

### BRIEF DESCRIPTION OF DRAWINGS

FIG. 1 is a view schematically illustrating a cross section of a film according to a first embodiment.

FIG. 2 is a view schematically illustrating a cross section of a film according to a second embodiment.

Each of FIG. 3a, FIG. 3b, FIG. 3c, FIG. 3d, and FIG. 3e is a view schematically illustrating a step of a method of manufacturing the film in FIG. 2.

FIG. 4a and FIG. 4b are views schematically illustrating steps subsequent to the steps in FIG. 3.

FIG. 5a and FIG. 5b are views schematically illustrating steps subsequent to the steps in FIG. 4.

Each of FIG. 6a and FIG. 6b is a view schematically illustrating a step of a method of manufacturing a film in a modified example.

FIG. 7 is a view schematically illustrating a cross section of a film according to a third embodiment.

Each of FIG. 8a and FIG. 8b is a view schematically illustrating a step of a method of manufacturing the film in FIG. 7.

FIG. 9 is a view schematically illustrating a cross section of a film according to a fourth embodiment.

FIG. 10 is a view schematically illustrating a step of a method of manufacturing the film in FIG. 9.

FIG. 11 is a view schematically illustrating a cross section of a film according to a fifth embodiment.

Each of FIG. 12a and FIG. 12b is a view schematically illustrating a step of a method of manufacturing the film in FIG. 11.

FIG. 13a is a view schematically illustrating a test device used for wind tunnel tests of Examples. FIG. 13b is a view schematically illustrating a wind tunnel model and a magnetic suspension and balance system that are provided inside the test device in FIG. 13a.

FIG. 14a is a side view illustrating an exemplary wind tunnel model. FIG. 14b is a partial sectional view of the wind tunnel model in FIG. 14a.

FIG. 15a is a view schematically illustrating a cross section of a film in each Example attached to a test subject. FIG. 15b is a view schematically illustrating a cross section of a film in each Comparative Example attached to a test subject.

FIG. 16 is a graph showing results of the wind tunnel tests for the films in Examples and the films in Comparative Examples.

Each of FIG. 17a and FIG. 17b is a view schematically illustrating a cross section of a film in a modified example.

Each of FIG. 18a and FIG. 18b is a view schematically illustrating a cross section of a film in a modified example.

FIG. 19a is a perspective view of film in a modified example. FIG. 19b is a plan view of a film in another modified example.

### DESCRIPTION OF EMBODIMENTS

Now, with reference to the drawings, various modes of a film according to the present disclosure is described. In the description of the drawings, identical or equivalent elements are denoted by the same reference signs, and duplicate descriptions of such elements are omitted. Furthermore, the drawings are given with a portion simplified or embellished for easy understanding, and the dimensional ratios, the angles, and the like are not limited to those shown in the drawings.

The term “film” in the present disclosure is a film-like member to be attached to an object so as to exert a predetermined function, and includes a thin film-like member to be attached to a moving body, for example. The “moving body” is a body that moves, and includes a transportation instrument such as a vehicle, a watercraft, an aircraft, and a rocket, and a moving machine such as a blade of a wind power plant. The “vehicle” includes a machine capable of traveling such as an automobile, a bicycle, a train, and a bullet train. Further, a “moving direction” indicates a direction in which the moving body moves. In the present disclosure, the film is attached to the surface of the moving body in order to enhance aerodynamic performance of the moving body. “Aerodynamic performance” indicates performance of aerodynamism with respect to the moving body during moving of the moving body, and includes low air resistance or low friction resistance against the moving body, for example.

### First Embodiment

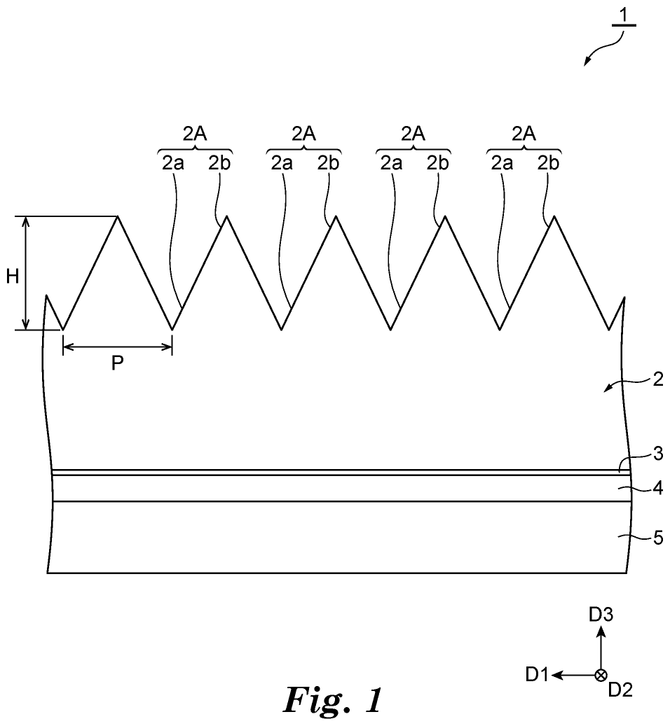

As illustrated in FIG. 1, a film 1 according to a first embodiment is, for example, attached to a surface of a moving body, and enhances aerodynamic performance of the moving body. The film 1 is attached to the surface of the moving body, and thus air resistance against the moving body is reduced. FIG. 1 is a view illustrating a laminating structure of the film 1. In the film 1, a base layer 2, a primer layer 3, an adhesive agent layer 4, and a release liner 5 are laminated in the stated order from the front side (a side opposite to the surface positioned on the moving body side at the time of being attached to the moving body).

For example, the material of the base layer 2 includes at least any of polyvinyl chloride (PVC), titanium dioxide, phosphate ester, diisobutyl ketone, solvent naphtha, diabenazole, an acrylic polymer, polyurethane, polyvinylidene fluoride (PVDF), a polymethyl methacrylate resin (PMMA), and an alloy of PVDF and PMMA. The base layer 2 may include at least any of a UV light absorbing agent and a plasticizer. As one example, the material of the primer layer 3 may include at least any of an aminoethylating acrylic polymer, toluene, and isopropyl alcohol.

The base layer 2 may be colorless and transparent, or may be colored with white or the like. The base layer 2 may be colored and transparent, or may be colored and opaque. The base layer 2 includes recesses and protrusions 2A on a surface. The recesses and protrusions 2A include a plurality of recessed parts 2a and a plurality of protruding parts 2b, and the recessed parts 2a and the protruding parts 2b are alternately arrayed along a first direction D1. Both the recessed parts 2a and the protruding parts 2b extend along a second direction D2 crossing with (orthogonal to, for example) the first direction D1, and the second direction D2 corresponds to the moving direction of the moving body.

For example, the recesses and protrusions 2A of the base layer 2 form a fine structure extending in the moving direction of the moving body, and extend in an airflow direction during moving of the moving body. Further, the recessed parts 2a are recessed in a third direction D3 being a thickness direction of the film 1, and the protruding parts 2b protrude in the third direction D3. For example, both the recessed parts 2a and the protruding parts 2b are formed in a triangle shape. That is, the recesses and protrusions 2A may be formed in a triangular wave shape. For example, an angle of an apex of the protruding part 2b (a bottom of the recessed parts 2a) may be from 40 degrees to 80 degrees or may be 60 degrees, and may be changed as appropriate.

As one example, the recessed parts 2a and the protruding parts 2b are aligned at an equal interval. For example, a width P of the recess and protrusion 2A is from 1 μm to 500 μm, may be from 40 μm to 100 μm, and may be changed as appropriate. Note that, the width P may be a distance between a bottom of a certain recessed part 2a and a bottom of the adjacent recessed part 2a, and may be a distance between an apex of a certain protruding part 2b and an apex of the adjacent protruding part 2b.

Further, both the recessed parts 2a and the protruding parts 2b may be formed in an isosceles triangular shape. In this case, a distance from the bottom of the recessed part 2a to the apex of the protruding part 2b in the first direction D1 is a half of the width P. For example, a height H of the recess and protrusion 2A is from 1 μm to 500 μm, may be from 40 μm to 100 μm, and may be changed as appropriate. The height H may be a height of the apex of the protruding part 2b with respect to the bottom of the recessed part 2a. Note that, a thickness of the adhesive agent layer 4 is, for example, from 10 μm to 70 μm, and is 40 μm as one example. A thickness of the release liner 5 is, for example, from 40 μm to 250 μm, and is 125 μm as one example. Note that, at least any of the primer layer 3, the adhesive agent layer 4, and the release liner 5 may be omitted.

As described above, the film 1 is a film that enhances aerodynamic performance of the moving body, and the recesses and protrusions 2A extending in the moving direction of the moving body are formed on the surface of the film 1. Therefore, on the moving body to which the film 1 is attached, air being resistance against moving flows smoothly along the recesses and protrusions 2A when the moving body moves in the moving direction. With this, air resistance caused on the surface of the moving body can be reduced.

The film 1 including the recesses and protrusions 2A extending in the moving direction of the moving body is attached to the moving body. With this, air resistance during moving of the moving body can be reduced, and aerodynamic performance can be enhanced. As a result, fuel consumption of the moving body can be reduced, and hence cost such as fuel consumption can be reduced. Further, the film 1 may include the adhesive agent layer 4 that causes the film 1 to adhere to the moving body. In this case, the film 1 including the recesses and protrusions 2A on the surface can be attached easily on the moving body.

### Second Embodiment

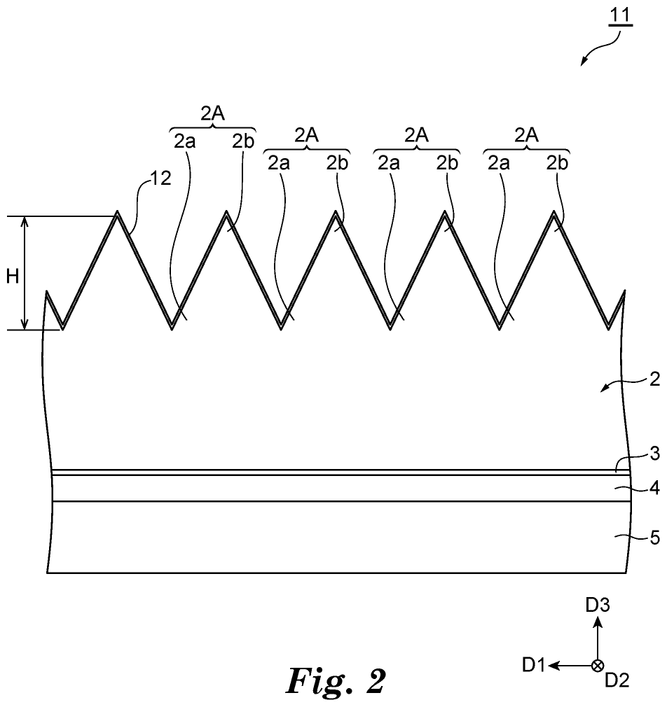

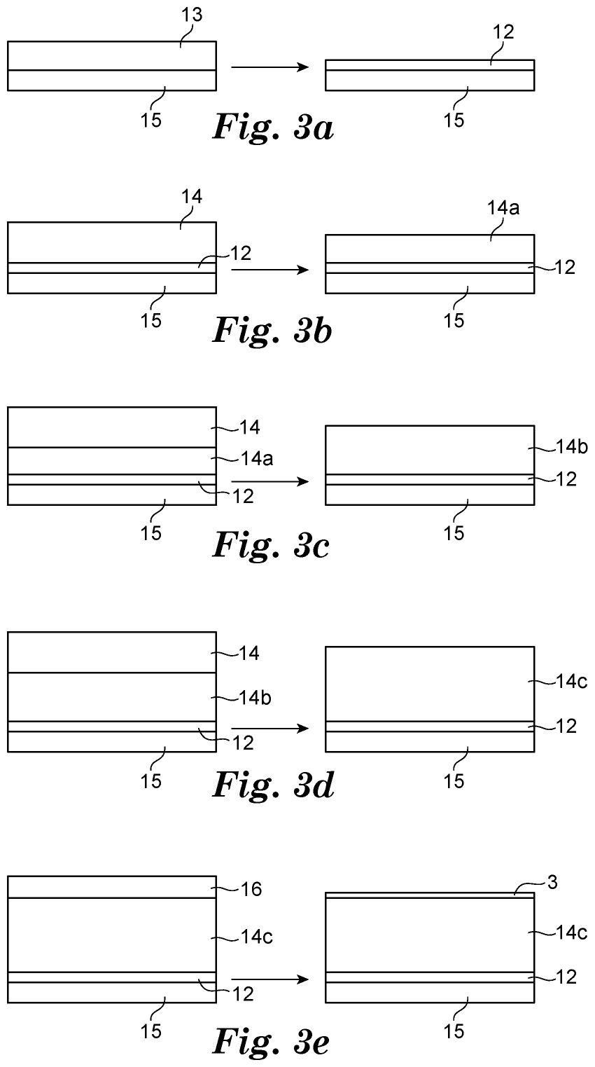

Next, a film 11 according to a second embodiment is described with reference to FIG. 2. As illustrated in FIG. 2, the film 11 is different from that in the first embodiment in that the recesses and protrusions 2A of the base layer 2 are further coated with a hydrophilic coating layer 12. In the following description, descriptions matching those in the embodiment described above are omitted as appropriate. Incidentally, “hydrophilicity” indicates a property that tends to bind to water or a property that tends to be dissolved in water, and the “hydrophilic coating layer” indicates a coating layer that enhances hydrophilicity.

The hydrophilic coating layer 12 has, for example, a self-cleansing function (a self-cleaning function). As described above, the recesses and protrusions 2A of the base layer 2 form a fine structure, which reduces air resistance and enhances aerodynamic performance. When the recesses and protrusions 2A are caused to exert a function of enhancing aerodynamic performance, the recesses and protrusions 2A are required to be cleansed in some cases. When the recesses and protrusions 2A are coated with the hydrophilic coating layer 12 having a self-cleaning function, foreign objects adhering to the recesses and protrusions 2A are removed together with moisture due to hydrophilicity of the hydrophilic coating layer 12.

The hydrophilic coating layer 12 is formed of a hydrophilic material, and may be formed of a weatherproofing material. “Weatherproofing” includes UV light resistance, and may further include heat resistance. “Having weatherproofing” indicates that the film is less liable to change in quality when the film is attached to the moving body outdoors, for example. The material of the hydrophilic coating layer 12 may include at least any of butyl acetate, a silica-containing acrylic resin, HDI isocyanurate, and HDI biuret, for example. The hydrophilic coating layer 12 may include, for example, a UV light absorbing agent. In this case, the hydrophilic coating layer 12 and the recesses and protrusions 2A can be protected from UV light.

Next, one example of a method of manufacturing the film 11 is described. First, as illustrated in FIG. 3a, for example, a step of forming a hydrophilic coating layer is performed. As a specific example, a solution 13 is applied on a peeling member 15 formed of polyethylene terephthalate (PET), and heating is performed in an oven for 30 seconds at 155 degrees centigrade. In this manner, the hydrophilic coating layer 12 having a thickness of 3 mm is formed. Next, as illustrated in FIG. 3b, for example, a while PVC solution 14 is applied on the hydrophilic coating layer 12, and heating is performed. As a specific example, the hydrophilic coating layer 12 to which the solution 14 is applied and the peeling member 15 are heated in an oven for 60 seconds at 65 degrees centigrade, for 30 seconds at 155 degrees centigrade, and then for 60 seconds at 180 degrees centigrade. In this manner, a layer 14a having a thickness of 56 μm is obtained.

As illustrated in FIG. 3c, the solution 14 is applied on the layer 14a, and is heated. For example, heating is performed in an oven for 60 seconds at 65 degrees centigrade, for 30 seconds at 155 degrees centigrade, and then for 90 seconds at 180 degrees centigrade. In this manner, a layer 14b having a thickness of 112 μm is obtained. After that, as illustrated in FIG. 3d, the solution 14 is further applied on the layer 14b, and is heated. For example, heating is performed in an oven for 60 seconds at 65 degrees centigrade, for 30 seconds at 155 degrees centigrade, and then for 120 seconds at 205 degrees centigrade. In this manner, a layer 14c having a thickness of 168 μm is obtained. The layer 14c is a layer formed as the base layer 2 later. After the layer 14c is obtained, a step of forming the primer layer is performed. For example, as illustrated in FIG. 3e, a primer solution 16 is applied on the layer 14c, and heating is performed. At this time, heating is performed in an oven for 60 seconds at 50 degrees centigrade as one example. Through this heating, the primer layer 3 is obtained.

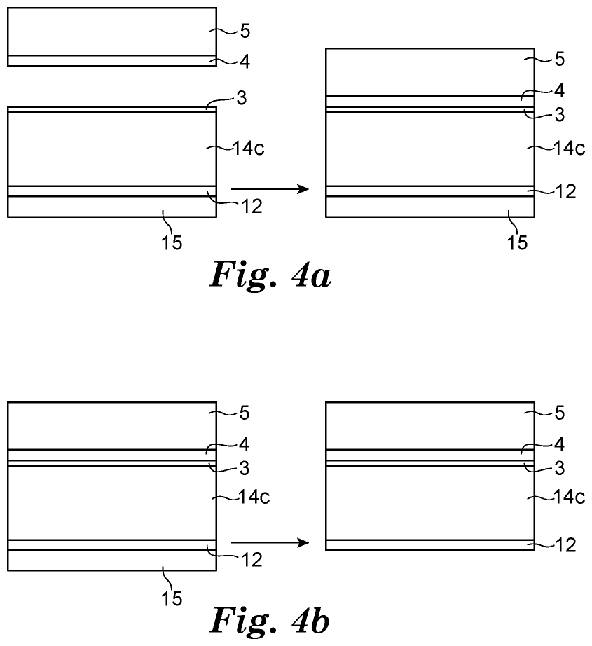

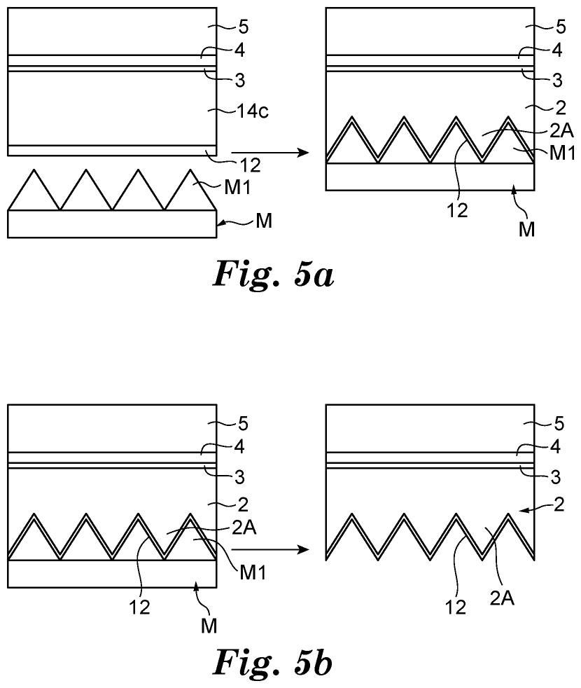

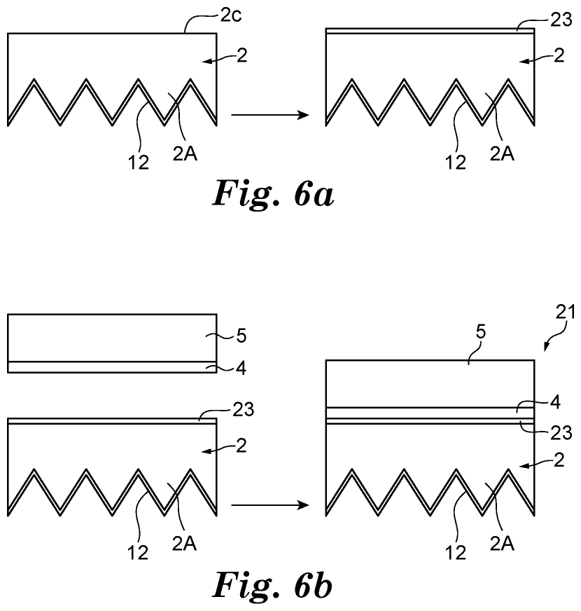

Subsequently, a step of forming the adhesive agent layer is performed. For example, as illustrated in FIG. 4a, the acrylic adhesive agent layer 4 provided with the release liner 5 is attached to the primer layer 3. After that, as illustrated in FIG. 4b and FIG. 5a, the peeling member 15 is peeled off from the hydrophilic coating layer 12, and the hydrophilic coating layer 12 and the layer 14c (the base layer 2) are heated. Also, the hydrophilic coating layer 12 and the base layer 2 are pressed against a mold M.

The mold M includes recesses and protrusions M1 formed in the same shape as the recesses and protrusions 2A described above. Thus, by pressing the hydrophilic coating layer 12 and the base layer 2 that are heated against the recesses and protrusions M1 of the mold M, the hydrophilic coating layer 12 and the base layer 2 are softened and deformed in conformity with the shape of the recesses and protrusions M1. The heated and pressed base layer 2 is deformed in conformity with the shape of the recesses and protrusions M1, and thus the recesses and protrusions 2A are obtained. That is, the recesses and protrusions 2A are obtained through heat-pressing of the base layer 2. Further, as illustrated in FIG. 5b, heating is terminated, and the hydrophilic coating layer 12 and the base layer 2 are cured. After that, the hydrophilic coating layer 12 and the base layer 2 are removed from the mold M, and then the film 11 is completed.

Incidentally, in a case of a film including recesses and protrusions on a surface, dust adheres on, or wax, rain water, or the like enter recessed parts of the recesses and protrusions in some cases. When foreign objects enter the recessed parts of the film as described above, there arises concern over reduction in an effect of reducing air resistance caused on the surface. Therefore, prevention of foreign objects from entering the recessed parts of the film is an important key in some cases. In view of the circumstances described above, the film 11 may include the hydrophilic coating layer 12 that coats the recesses and protrusions 2A.

In this case, the recesses and protrusions 2A of the film 11 are coated with the hydrophilic coating layer 12, and thus the hydrophilic coating layer 12 can remove foreign objects such as dust and moisture by washing away the foreign objects together with moisture even when the foreign objects enter the recessed parts 2a of the recesses and protrusions 2A. That is, the hydrophilic coating layer 12 functions as a self-cleaning layer that removes foreign objects entering the recessed parts 2a of the recesses and protrusions 2A by cleansing.

### Third Embodiment

Next, a film 21 according to a third embodiment is described. As illustrated in FIG. 6b, the film 21 is different from those in the embodiments described above in that a printed layer 23 is provided in place of the primer layer 3. For example, the printed layer 23 is an intermediate layer positioned between the recesses and protrusions 2A and the adhesive agent layer 4, and a layer subjected to printing. Further, in the film 21, the base layer 2 may be transparent. In this case, printing on the printed layer 23 can be clear. For example, on the printed layer 23, at least any of a character, a pattern, a drawing, and a picture may be printed. As one example, the printed layer 23 may display information relating to the moving body or may decorate the moving body. In this case, design of the moving body can be improved by the printed layer 23.

As a method of manufacturing the film 21, for example, first, a laminated body obtained by peeling the peeling member 15 off form the layer 14c illustrated in FIG. 3d is heat-pressed against the mold M in a similar manner described above, and the base layer 2 with the recesses and protrusions 2A exemplified in FIG. 6a is obtained. The printed layer 23 is formed on a flat surface 2c facing a side opposite to the recesses and protrusions 2A of the base layer 2. At this time, as one example, the flat surface 2c is subjected to printing and drying, and thus the printed layer 23 is obtained. After that, as illustrated in FIG. 6b, the adhesive agent layer 4 to which the release liner 5 is provided is attached to the printed layer 23. In this manner, the film 21 is completed.

As described above, the film 21 may include an intermediate layer positioned between the recesses and protrusions 2A and the adhesive agent layer 4. In this case, for example, when the printed layer 23 is provided as the intermediate layer, the intermediate layer may be used for purposes other than enhancement of aerodynamic performance or adhesion. As described above, when the printed layer 23 is provided as the intermediate layer, the printed layer 23 is subjected to desired printing, and hence decoration of the film 21 can be improved.

### Fourth Embodiment

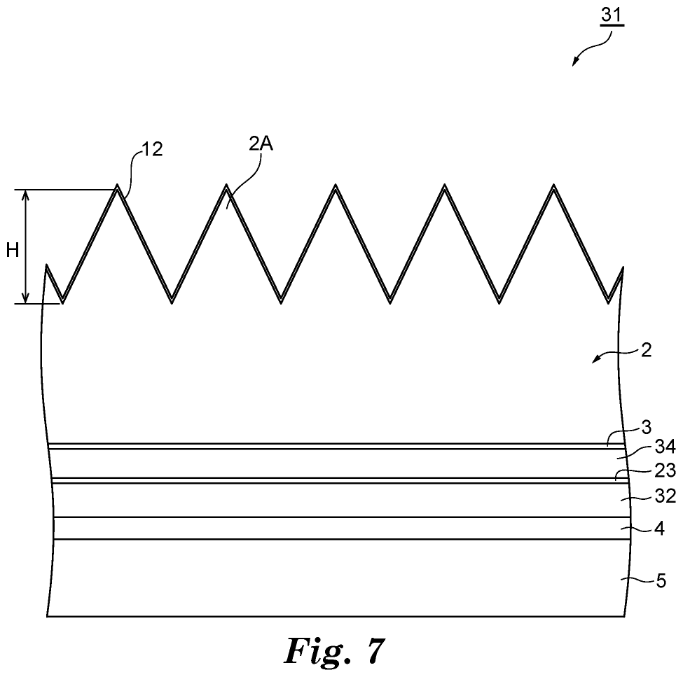

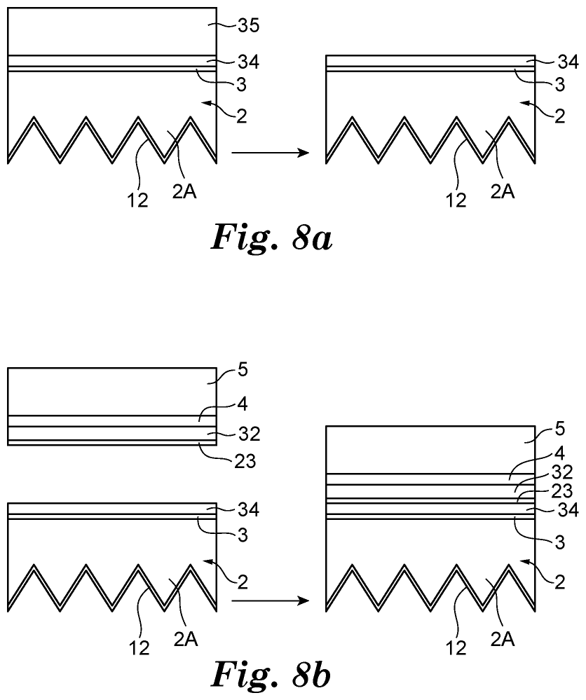

Subsequently, a film 31 according to a fourth embodiment is described with reference to FIG. 7. As illustrated in FIG. 7, the film 31 according to the fourth embodiment further includes a second base layer 32 positioned between the printed layer 23 and the adhesive agent layer 4, and a second adhesive agent layer 34 provided between the printed layer 23 and the primer layer 3. In other words, in the film 21 described above, the printed layer 23 is provided on the back side of the base layer 2. In the film 31, the printed layer 23 is provided on the front side of the second base layer 32.

For example, the second base layer 32 may be colored, and is white as one example. The material of the second base layer 32 may be the same as the material of the base layer 2, and is PVC as one example. A thickness of the second base layer 32 is, for example, from 10 μm to 90 μm, and 50 μm as one example. A thickness of the second adhesive agent layer 34 is, for example, from 10 μm to 50 μm, and 30 μm as one example.

As an example of a method of manufacturing the film 31, as illustrated in FIG. 8a and FIG. 8b, a release liner 35 is released from the second adhesive agent layer 34, and the printed layer 23 of the laminated body including the printed layer 23, the second base layer 32, the adhesive agent layer 4, and the release liner 5 is attached to the second adhesive agent layer 34. Similar to the film 21, the film 31 described above includes the printed layer 23 as the intermediate layer, and hence decoration of the film 31 can be improved. Further, the film 31 can be manufactured by attaching the printed layer 23 of the laminated body described above to the second adhesive agent layer 34, and thus manufacturing of the film 31 can be facilitated.

### Fifth Embodiment

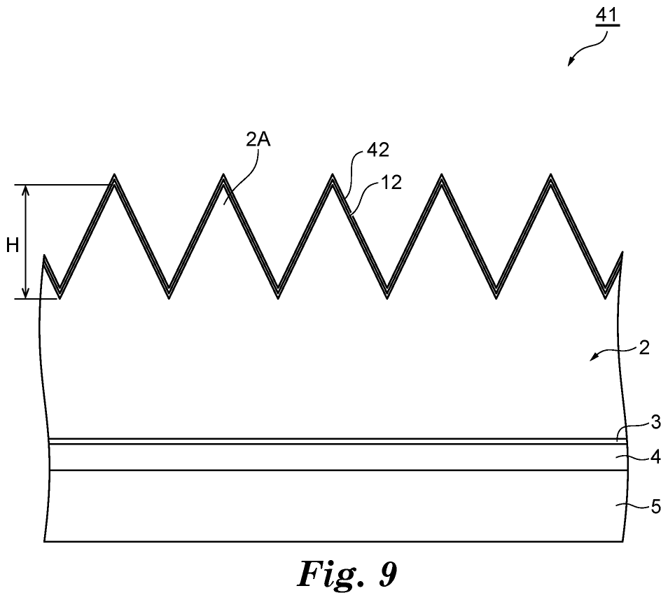

Next, a film 41 according to a fifth embodiment is described with reference to FIG. 9. The film 41 further includes a hydrophobic coating layer 42 in addition to the hydrophilic coating layer 12, the base layer 2, the primer layer 3, the adhesive agent layer 4, and the release liner 5 described above. In the present specification, “hydrophobicity” indicates a property with low hydrophilicity, which does not tend to be mixed with water or dissolved in water, and includes water repellency. The “hydrophobic coating layer” indicates a coating layer that enhances hydrophobicity.

The hydrophobic coating layer 42 has, for example, a water-repellent function. As one example, when ice adheres on the recesses and protrusions 2A of the base layer 2, there arises concern over degradation of aerodynamic performance of the recesses and protrusions 2A. However, ice adhering on the film 41 including the hydrophobic coating layer 42 can be removed easily due to a water-repellent function of the hydrophobic coating layer 42. Further, in a similar manner described above, the hydrophobic coating layer 42 can suppress adhesion of mud or the like on the film 41.

For example, the hydrophobic coating layer 42 may have a self-cleaning function, and may include a UV light absorbing agent. In this case, weatherproofing of the hydrophobic coating layer 42, the hydrophilic coating layer 12, and the like can be enhanced. The material of the hydrophobic coating layer 42 may include, for example, silicone and a fluorine-based resin. When the hydrophobic coating layer 42 having weatherproofing, for example, the hydrophobic coating layer 42 may be provided in place of the hydrophilic coating layer 12.

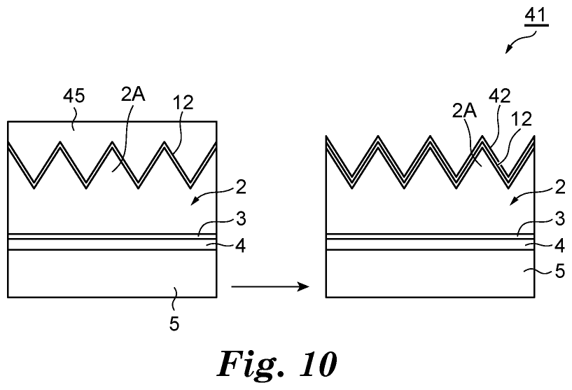

As illustrated in FIG. 10, as a method of manufacturing the film 41, first, a silicone solution 45 is applied with a meyer bar on the recesses and protrusions 2A of the base layer 2 including the hydrophilic coating layer 12, and is heated in an oven for 60 seconds at 100 degrees centigrade. With this, the film 41 including the hydrophobic coating layer 42 having a thickness of 0.6 μm is obtained.

As described above, the film 41 may include the hydrophobic coating layer 42 that coats the recesses and protrusions 2A. That is, the film 41 may include a water-repellent layer. In this case, moisture is less liable to adhere to the recesses and protrusions 2A of the film 41, foreign objects can be removed easily together with moisture from the recesses and protrusions 2A. Therefore, foreign objects are less liable to adhere to the recesses and protrusions 2A on the surface of the film 41.

### Sixth Embodiment

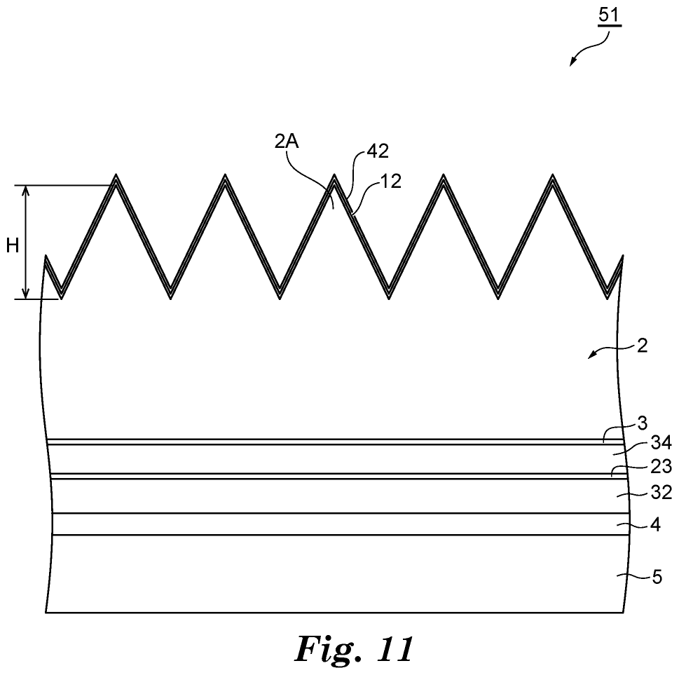

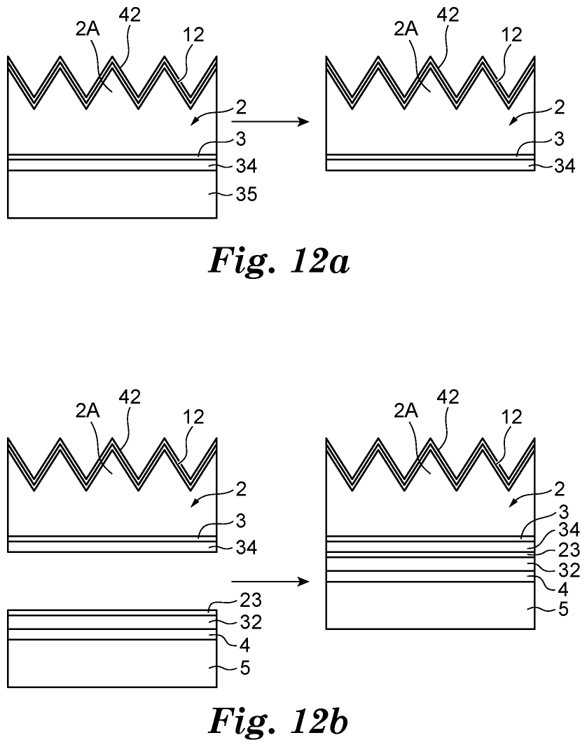

As illustrated in FIG. 11, a film 51 according to the fifth embodiment is different from the film 41 in that the printed layer 23, the second base layer 32, and the second adhesive agent layer 34 that are described above are included. As illustrated in FIG. 12a and FIG. 12b, as a method of manufacturing the film 51, the release liner 35 is released from the second adhesive agent layer 34, and the printed layer 23 of the laminated body including the printed layer 23, the second base layer 32, the adhesive agent layer 4, and the release liner 5 is attached to the second adhesive agent layer 34. As described above, in a similar manner described above, the film 51 includes the printed layer 23 as the intermediate layer, and hence decoration of the film 51 can be improved. Further, the film 51 can be manufactured by attaching the printed layer 23 of the laminated body described above to the second adhesive agent layer 34, and thus manufacturing of the film 51 can be facilitated.

### EXAMPLES

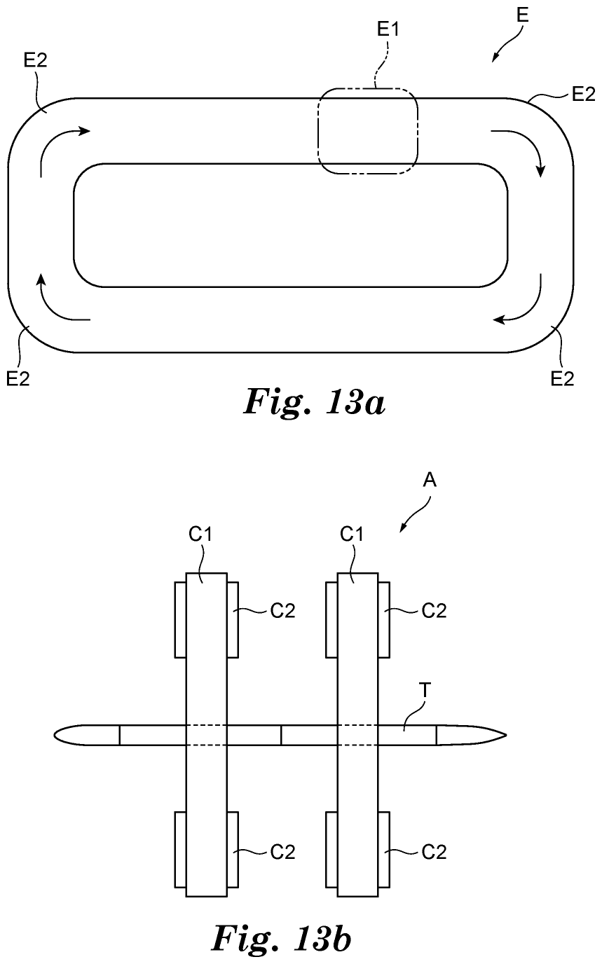

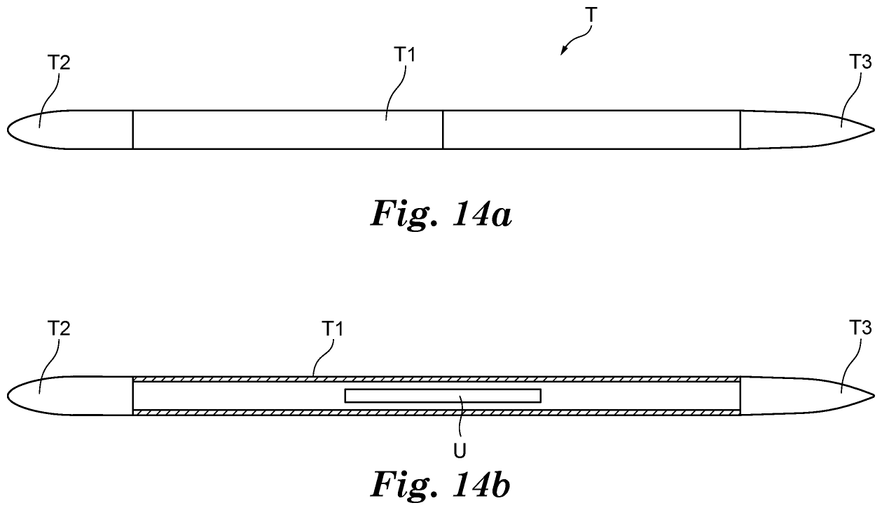

Next, Examples for the film according to the present disclosure are described. The present disclosure is not limited to Examples given below. In Examples, the film according to the present disclosure was subjected to wind tunnel tests, and an effect exerted by the film according to the present disclosure was checked. As illustrated in FIG. 13a and FIG. 13b, the wind tunnel tests were performed with a Magnetic Suspension and Balance System (MSBS) A arranged in wind tunnel establishment E.

The wind tunnel establishment E included an annular flow path through which wind from an air sending machine passed, and the wind flowed clockwise through four corner portions E2. The magnetic suspension and balance system A was arranged in a region E1 in a flow path of the wind tunnel establishment E, and the magnetic suspension and balance system A included a pair of air-core coils C1 and a plurality of magnetic suspending coils C2. A wind tunnel model T having a length of approximately 2.2 m was arranged between the plurality of magnetic suspending coils C2. As illustrated in FIG. 14a and FIG. 14b, the wind tunnel model T included a main body T1 formed in a bar-like shape and ends T2 and T3 formed in a stream-line shape positioned on both ends of the main body T1.

A permanent magnet U was arranged inside the main body T1, and the wind tunnel model T floated in the air between the plurality of magnetic suspending coils C2 due to a magnetic force of the permanent magnet U. The permanent magnet U was a neodymium magnet. The wind tunnel model T floated due to a magnetic force as described above, and hence an object for supporting the wind tunnel model T was not required. Thus, wind tunnel tests through use of the wind tunnel model T were able to be performed more accurately. In the tests, various measurements were performed with respect to the wind tunnel model T in Example 1, Example 2, Comparative Example 1, Comparative Example 2, and Comparative Example 3 described later. Specifications of the wind tunnel model T in Example 1, Example 2, Comparative Example 1, Comparative Example 2, and Comparative Example 3 were given as described below.

### Example 1

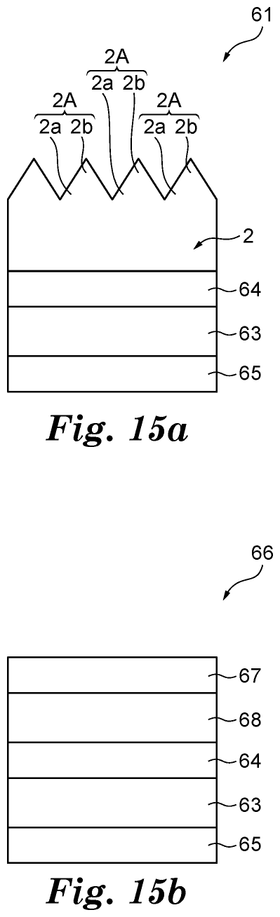

A film 61 was attached to the wind tunnel model T. As illustrated in FIG. 15a, in the film 61, the resin base layer 2 including the recesses and protrusions 2A described above, an adhesive agent layer 64 having a thickness of 30 μm, a second base layer 63 having a thickness of 50 μm, which was white and formed of PVC, and an adhesive agent layer 65 having a thickness of 30 μm were laminated. Both a height and a width of the recess and protrusion 2A were 100 μm.

### Example 2

The film 61 was attached to the wind tunnel model T. In the film 61, the resin base layer 2 including the recesses and protrusions 2A described above, the adhesive agent layer 64 having a thickness of 30 μm, the second base layer 63 having a thickness of 50 μm, which was white and formed of PVC, and the adhesive agent layer 65 having a thickness of 30 μm were laminated. Both a height and a width of the recess and protrusion 2A were 44 μm.

Comparative Example 1

A flat film 66 without the recesses and protrusions 2A described above as illustrated in FIG. 15b was attached to the wind tunnel model T. In the film 66, a resin layer 67 having a thickness of 30 μm, which included PVDF and PMMA, a resin layer 68 having a thickness of 75 μm, which included PMMA, the adhesive agent layer 64 having a thickness of 30 μm, the second base layer 63 having a thickness of 50 μm, which was white and formed of PVC, and the adhesive agent layer 65 having a thickness of 30 μm were laminated.

### Comparative Example 2

A film in which round holes (dimples) having a diameter of 160 μm were formed in place of the recesses and protrusions 2A described above was attached to the wind tunnel model T.

### Comparative Example 3

A film in which round holes (dimples) having a diameter of 53 μm were formed in place of the recesses and protrusions 2A described above was attached to the wind tunnel model T.

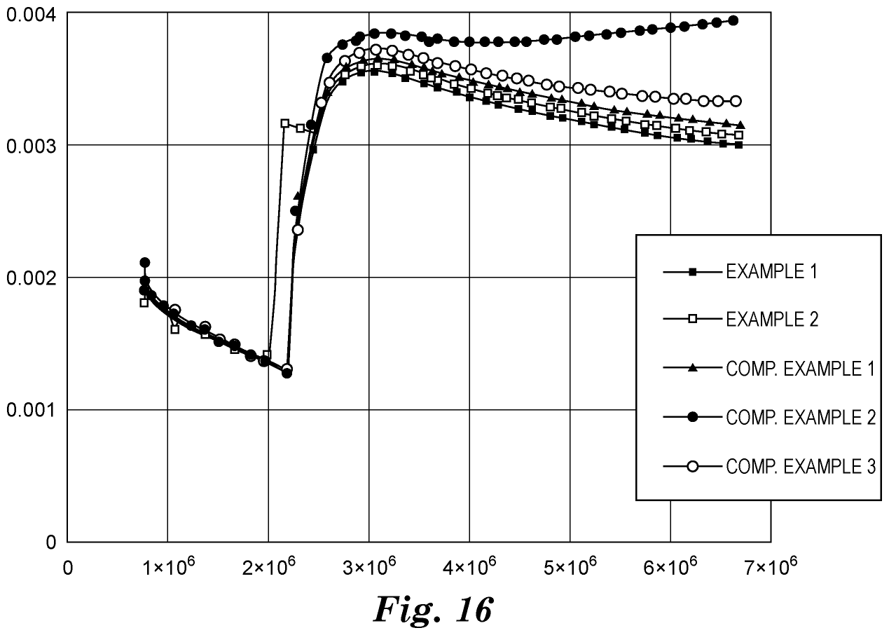

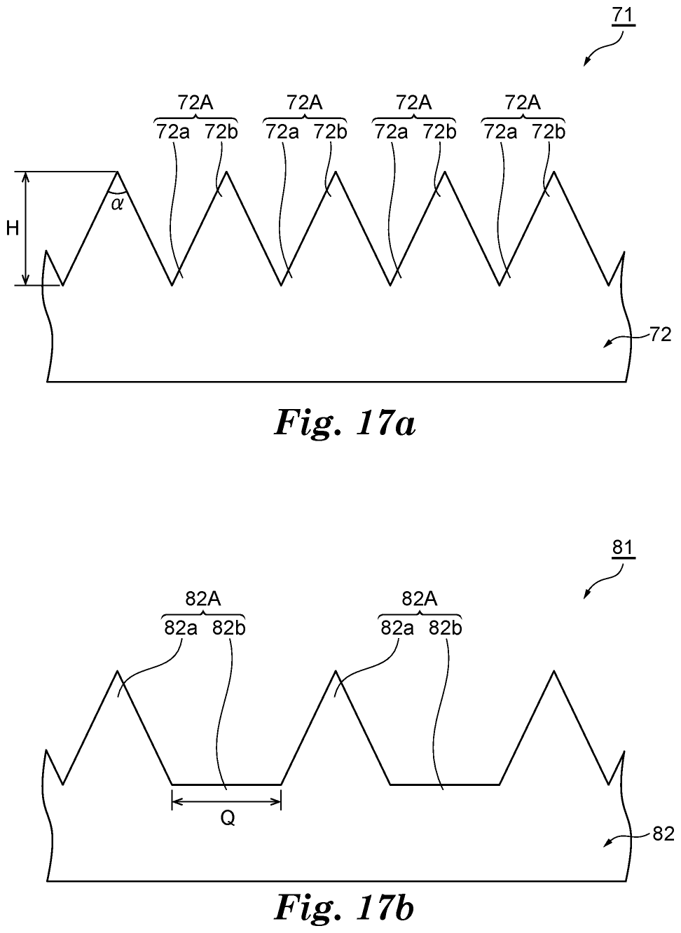

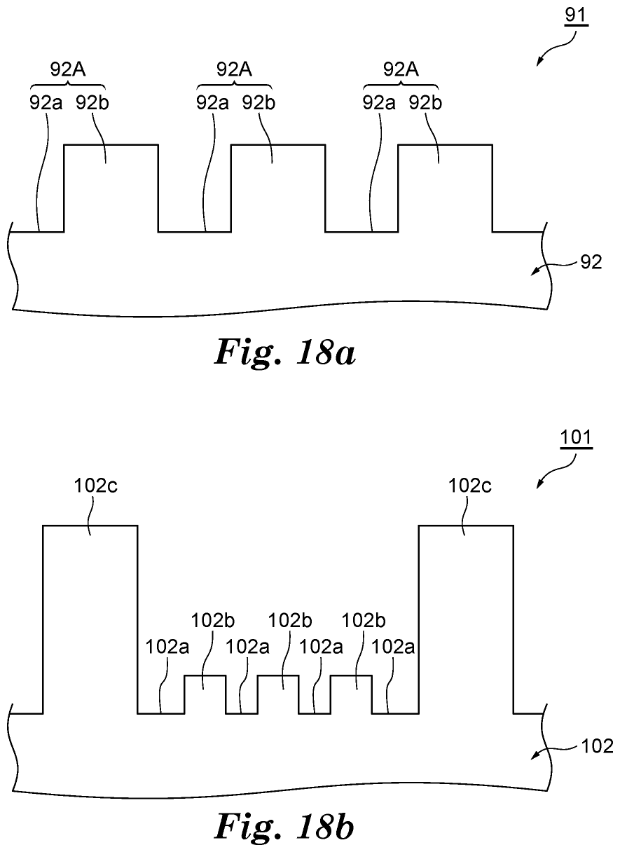

FIG. 16 is a graph for showing results of the wind tunnel tests through use of the magnetic suspension and balance system A with respect to the wind tunnel model T in Example 1, Example 2, Comparative Example 1, Comparative Example 2, and Comparative Example 3 described above. The vertical axis of the graph in FIG. 16 indicates a drag coefficient, and the horizontal axis of the graph in FIG. 16 indicates a Reynolds number. In the present wind tunnel tests, a drag coefficient of the wind tunnel model T was measured while increasing a speed of the wind passing through the wind tunnel model T.

The Reynolds number was increased together with increase of the wind speed. When the Reynolds number was 2.0×106 or less, the drag coefficient of the wind tunnel model T was reduced together with an increase of the Reynolds number in all Examples 1 and 2 and Comparative Examples 1 to 3. Note that, when the Reynolds number was 2.0×106, the wind speed was approximately 50 km/h. A flow in a boundary layer on the surface of the wind tunnel model T was presumably a laminar flow when the Reynolds number was 2.0×106 or less.

However, in a case where the flow in the boundary layer on the surface of the wind tunnel model T was presumably a turbulent flow when the Reynolds number was 2.0×106 or more, the wind tunnel model T in Comparative Examples 2 and 3 with the dimples had a drag coefficient more than that in Examples 1 and 2 and Comparative Example 1. As described above, it has been found out that the films with the dimples in Comparative Examples 2 and 3 did not exert an effect of reducing a drag in a region with the boundary layer that was presumably a turbulent flow.

In contrast, when the Reynolds number was 2.8×106 or more, the wind tunnel model T in Examples 1 and 2 had a drag coefficient less than that in Comparative Examples 1 to 3. Specifically, as compared to Comparative Example 1, the drag coefficient was able to be reduced by approximately 4.5% with the film 61 including the recesses and protrusions 2A having a height and a width of 100 μm in Example 1. As compared to Comparative Example 1, the drag coefficient was able to be reduced by approximately 3% with the film 61 including the recesses and protrusions 2A having a height and a width of 44 μm in Example 2. It was found that Example 1 with the larger height and the larger width of the recess and protrusion 2A had a drag coefficient that was further reduced than that in Example 2. As described above, it was found that the film 61 with the recesses and protrusions 2A in Examples 1 and 2 exerted an effect of reducing a drag in a region with the boundary layer that was presumably a turbulent flow.

Detailed descriptions have been given above for the embodiments and Examples of the present invention. However, the present invention is not limited to the embodiments or Examples described above. For example, a thickness, a size, a shape, a material, the number, and an arrangement mode of each part of the film according to the present disclosure are not limited to the embodiments or Examples described above, and may be changed as appropriate. Note that, the thickness of the film is not particularly limited. However, in view of reducing aerodynamic drag, the film is preferably thin. In the following, modified examples for the film according to the present disclosure are further described. As one specific example, for example, as illustrated in FIG. 17a, in a case of a film 71 including a base layer 72 on which recesses and protrusions 72A with continuous recessed parts 72a and protruding parts 72b are formed, a height H of the protruding part 72b and an angle α of the protruding part 72b may be changed as appropriate. In the embodiments described above, the example in which the height H is from 1 μm to 500 μm is described. As one example, the height H may be 100 μm or 150 μm. The angle α of the protruding part 72b may be, for example, from 10 degrees to 80 degrees, and may be 26.5 degrees or 53 degrees as one example.

As illustrated in FIG. 17b, an exemplary film 81 includes a base layer 82 on which recesses and protrusions 82A having intervals 82b between a protruding part 82a and the adjacent protruding part 82a are formed. The interval 82b indicates a flat part between the pair of protruding parts 82a. A width Q of the interval 82b is, for example, from 10 μm to 200 μm, and may be 50 μm, 75 μm, 100 μm, or 150 μm as one example.

As illustrated in FIG. 18a, a film 91 as one example may include a base layer 92 including recesses and protrusions 92A formed of recessed parts 92a and protruding parts 92b in a rectangular shape. The film may include a base layer including recesses and protrusions formed of recessed parts and protruding parts in a trapezoidal shape, in place of the recessed parts 92a and the protruding parts 92b in a rectangular shape. Further, as illustrated in FIG. 18b, a film 101 as another example may include a base layer 102 on which small recessed parts 102a and small protruding parts 102b are arranged between a pair of large protruding parts 102c. As described above, the shape of the recesses and protrusions of the base layer is not limited to the recesses and protrusions 2A in a triangular wave shape, and may be changed as appropriate.

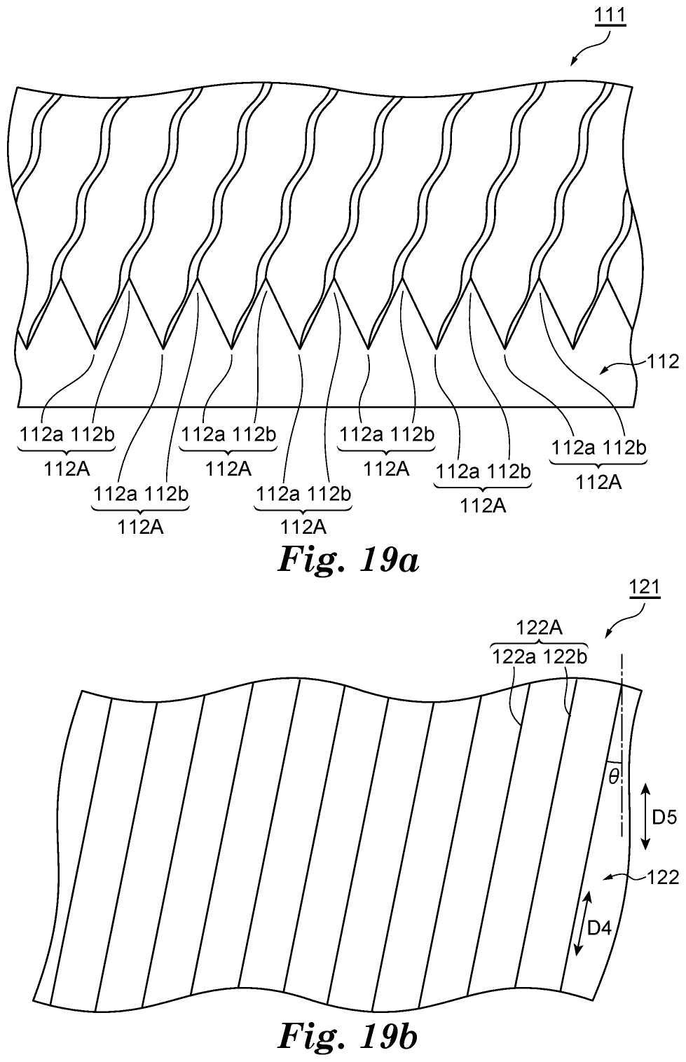

As illustrated in FIG. 19a, an exemplary film 111 may include a base layer 112 including recesses and protrusions 112A formed of recessed parts 112a and protruding parts 112b that are wavy in a plan view (as seen from an out-of-plane direction). As illustrated in FIG. 19b, an exemplary film 121 may include a base layer 122 including recesses and protrusions 122A formed of recessed parts 122a and protruding parts 122b extending in a direction D4 inclined with respect to a moving direction D5 of a moving body. An angle θ of the direction D4 with respect to the moving direction D5 is, for example, more than 0 degrees and is 10 degrees or less.

As described above, a shape, a size, a direction, and an arrangement mode of the recesses and protrusions of the film may be changed as appropriate.

### REFERENCE SIGNS LIST

1, 11, 21, 31, 41, 51, 61, 71, 81, 91, 101, 111, 121 Film
2, 72, 82, 92, 102, 112, 122 Base layer
2A, 72A, 82A, 92A, 112A, 122A Recess and protrusion
2a, 72a, 92a, 102a, 112a, 122a Recessed part
2b, 72b, 92b, 102b, 102c, 112b, 122b Protruding part
2c Flat surface
3 Primer layer
4, 64, 65 Adhesive agent layer
5, 35 Release liner
12 Hydrophilic coating layer
13, 14, 45 Solution
14a, 14b, 14c Layer
15 Peeling member
16 Primer solution
23 Printed layer (intermediate layer)
32, 63 Second base layer
34 Second adhesive agent layer
42 Hydrophobic coating layer
C1 Air-core coil
C2 Magnetic suspending coil
D1 First direction
D2 Second direction
D3 Third direction
E Wind tunnel establishment
E1 Region
E2 Corner portion
M Mold
M1 Recess and protrusion
P Width
T Wind tunnel model
T1 Main body
T2, T3 End
U Permanent magnet

1. A film to be attached to a moving body that moves in a predetermined moving direction, the film comprises:
recesses and protrusions configured to enhance aerodynamic performance of the moving body on a surface of the film.

2. The film according to claim 1, further comprising a hydrophilic coating layer configured to coat the recesses and protrusions.

3. The film according to claim 1, further comprising a hydrophobic coating layer configured to coat the recesses and protrusions.

4. The film according to claim 1, further comprising an adhesive agent layer configured to cause the film to adhere to the moving body.

5. The film according to claim 4, further comprising an intermediate layer that is positioned between the recesses and protrusions and the adhesive agent layer.
